(19) United States
(12) Patent Application Publication
(10) Pub. No.: US 2013/0332751 A1
(43) Pub. Date: Dec. 12, 2013

(54) POWER SUPPLY AND PROGRAM

(71) Applicant: Sanken Electric Co., Ltd., Niiza-shi (JP)

(72) Inventor: Tetsuki IWATA, Niiza-shi (JP)

(21) Appl. No.: 13/913,571

(22) Filed: Jun. 10, 2013

(30) Foreign Application Priority Data
Jun. 11, 2012 (JP) 2012-131516

(51) Int. Cl. G06F 1/26

(52) U.S. Cl. CPC G06F 1/26
USPC 713/300

(57) ABSTRACT

A power supply includes a storage device and a virtual machine power data transfer unit. The storage device is configured to store virtual machine power management data in which an identifier of a virtual machine run in emulation by a virtual host computer fed with power from the power supply, and power information on the virtual machine are associated with each other. The virtual machine power data transfer unit is configured to, when a virtualization management server migrates the virtual machine run in emulation by the virtual host computer fed with power from the power supply to a migration destination virtual host computer fed with power from a different power supply, extract the power information on the migrated virtual machine out of the virtual machine power management data, and transfer the power information to the different power supply.

### CROSS-REFERENCE TO RELATED APPLICATIONS

This application is based upon and claims the benefit of priority from the prior Japanese Patent Application No. 2012-131516 (filed Jun. 11, 2012); the entire contents of which are incorporated herein by reference.

### BACKGROUND OF THE INVENTION

1. Field of the Invention

The present invention relates to a power supply, a program, a control method, a power management apparatus, and a power management program for feeding power to computers.

2. Description of the Related Art

Virtualization management is generally used for effective utilization of the resources of physical computers. The virtualization management uses the physical computers as virtual hosts. Each virtual host is configured to run one or multiple virtual machines (VMs) in emulation. In the virtualization management, a VM is sometimes migrated to a different virtual host depending upon the running situations of the VMs. Using a structure that allows flexible migration of a VM to any virtual host makes it possible to effectively utilize the resources of the physical computers.

Meanwhile, there are methods that use a power control device to reduce the power consumption of the physical computers (see Japanese Patent Application Publication No. 2008-269249, for example). In the method described in Japanese Patent Application Publication No. 2008-269249, the power control device collects the load statuses of systems, migrates a system to a given physical computer on the basis of the load statuses, and turns off the power of the unselected physical computer. By causing the power control device to perform both virtualization management and power management as described above, the power consumption of the physical computers can be expected to be reduced.

However, the method described in Japanese Patent Application Publication No. 2008-269249 has a problem that the power control device becomes unable to perform not only the power management but also the virtualization management if there is a power fault in the power supply feeding power to the power control device.

In view of such a circumstance, a power supply configured to perform virtualization management of VMs and power management of the VMs and their virtual hosts has been proposed (see Japanese Patent Application Publication No. 2012-038157). According to the method described in Japanese Patent Application Publication No. 2012-038157, the power supply manages so as to perform the virtualization management and the power feed in conjunction with each other in accordance with preset schedule data. Thus, the system can be operated stably.

Moreover, there is a configuration using PowerChute Network Shutdown (PCNS) or the like in a general virtual system for the purpose of power control (see IBM Japan, Ltd. “IBM UPS Management in VMware ESX/ESXi 4.x Environment”, Page 5 “What is PowerChute Network Shutdown (PCNS)?”, [online], 2011, IBM Japan, Ltd., [searched May 17, 2012], the Internet <http://www-06.ibm.com/jp/domino04/pc/support/Sylphd07.nsf/1e97b730bd4fa 8f249256a840020d047/c73c9977ac705 ccb4925787700436807/$ FILE/VMware_esx4_UPS_mgmt.pdf> (hereinafter, Non-patent Document), for example). When power feed to an UPS is stopped due to a power failure, computers fed with power from this UPS must be shut down while the battery of the UPS feeds power. Thus, in the method described in Non-patent Document, when power feed to an UPS is stopped due to a power failure, the UPS notifies a PCNS on the service console of a virtual system that the power feed has been stopped. In response, a virtual host computer starts a shutdown process, starting with a shutdown of the guest OS of each VM. Once the shutdown of the guest OS is complete, the virtual host computer is shut down. Such a PCNS is installed and executed on a VM in some cases.

### SUMMARY OF THE INVENTION

However, there are cases where even the invention described in Japanese Patent Application Publication No. 2012-038157 or the technique described in Non-patent Document cannot run VMs appropriately.

In general, in the event of an emergency such as a power failure, a power supply such as an UPS feeds power to information apparatuses by using the power of a storage battery charged in advance. After a power failure occurs, each information apparatus stably shuts down to protect data therein while the UPS or the like feeds power. The time required for this shutdown varies from one information apparatus to another. In addition, there is a restriction that the shutdown must be done within a period of time for which the UPS can feed power.

This method has been employed in virtual systems as well. In the event of a power failure, a power supply notifies its virtual host of the occurrence of the power failure. The virtual host shuts down each VM which the virtual host runs in emulation, prior to its own shutdown. Once the shutdown of all the VMs is complete, the virtual host stably shuts itself down and powers off.

Nonetheless, there are still cases where such virtual systems cannot appropriately shut down VMs.

For example, for a shutdown of a VM during a power failure, a delay time to stop is set in advance; the VM starts to shut down after the elapse of the predetermined delay time to stop since the occurrence of the power failure. This delay time to stop is set such that the VM can shut down within a period of time for which the power supply can feed power, and therefore depends upon the ability of the power supply that feeds power to the virtual host running the VM in emulation.

However, because VMs are migrated to different virtual host computers when necessary, the delay time to stop set to a VM may not always match the ability of the power supply feeding power to the migration destination virtual host computer that runs this VM in emulation. Thus, if the ability of the power supply used at the migration destination is lower than the ability the VM requires for its power supply, the VM may fail to shut down in such a manner that the data therein is well protected.

In view of the above circumstances, there is a demand for the development of a technique which allows a power supply to control power source information on a VM to match the power supply and thereby improves the reliability of virtualization management.

Thus, an object of the present invention is to provide a power supply, a program, a control method, a power management apparatus, and a power management program capable of improving the reliability of virtualization management.

To solve the above problems, a first aspect of the present invention relates to a power supply which feeds power to a virtual host computer running a virtual machine in emulation, the virtual machine controlled by a virtualization management server. Specifically, the power supply according to the first aspect of the present invention includes: a storage device configured to store virtual machine power management data in which an identifier of the virtual machine run in emulation by the virtual host computer fed with power from the power supply, and power information on the virtual machine are associated with each other; and a virtual machine power data transfer unit configured to, when the virtualization management server migrates the virtual machine run in emulation by the virtual host computer fed with power from the power supply to a migration destination virtual host computer fed with power from a different power supply, extract the power information on the migrated virtual machine out of the virtual machine power management data, and transfer the power information to the different power supply.

A second aspect of the present invention relates to a program being on a non-transitory computer-readable storage medium for a power supply which feeds power to a virtual host computer running a virtual machine in emulation, the virtual machine controlled by a virtualization management server. Specifically, the program according to the second aspect of the present invention is configured to execute the steps of: storing virtual machine power management data in which an identifier of the virtual machine run in emulation by the virtual host computer fed with power from the power supply, and power information on the virtual machine are associated with each other; and when the virtualization management server migrates the virtual machine run in emulation by the virtual host computer fed with power from the power supply to a migration destination virtual host computer fed with power from a different power supply, extracting the power information on the migrated virtual machine out of the virtual machine power management data, and transferring the power information to the different power supply.

A third aspect of the present invention relates to a control method used for a power supply which feeds power to a virtual host computer running a virtual machine in emulation, the virtual machine controlled by a virtualization management server. Specifically, the control method according to the third aspect of the present invention includes the steps of: storing virtual machine power management data in which an identifier of the virtual machine run in emulation by the virtual host computer fed with power from the power supply, and power information on the virtual machine are associated with each other; and when the virtualization management server migrates the virtual machine run in emulation by the virtual host computer fed with power from the power supply to a migration destination virtual host computer fed with power from a different power supply, extracting the power information on the migrated virtual machine out of the virtual machine power management data, and transferring the power information to the different power supply.

A fourth aspect of the present invention relates to a power management apparatus connected to a first power supply which feeds power to a first virtual host computer and a second power supply which feeds power to a second virtual host computer. The power management apparatus according to the fourth aspect of the present invention includes: a storage device configured to store virtual machine power management data in which an identifier of each of the power supplies, an identifier of a virtual machine run in emulation by the virtual host computer fed with power from the power supply, and power information on the virtual machine are associated with each other; and a virtual machine power data transfer unit configured to, when a virtualization management server migrates the virtual machine from the first virtual host computer to the second virtual host computer, extract the power information on the migrated virtual machine out of the virtual machine power management data, and transfer the power information to the second power supply.

A power management program according to a fifth aspect of the present invention relates to a power management program used for a power management apparatus connected to a first power supply which feeds power to a first virtual host computer and a second power supply which feeds power to a second virtual host computer. Specifically, the power management program according to the fifth aspect of the preset invention is configured to cause a computer or a computer incorporated in a power management apparatus to execute the steps of: storing, in a storage device, virtual machine power management data in which an identifier of each of the power supplies, an identifier of a virtual machine run in emulation by the virtual host computer fed with power from the power supply, and power information on the virtual machine are associated with each other; and when a virtualization management server migrates the virtual machine from the first virtual host computer to the second virtual host computer, extracting the power information on the migrated virtual machine out of the virtual machine power management data, and transferring the power information to the second power supply.

### BRIEF DESCRIPTION OF THE DRAWINGS

FIGS. 1A and 1B are diagrams describing the system configuration of a virtual system according to an embodiment of the present invention.

FIG. 2 is a sequence diagram describing an outline of a control method according to the embodiment of the present invention.

FIG. 3 is a diagram describing the functional blocks of each virtual host computer according to the embodiment of the present invention.

FIG. 4 is a diagram describing the hardware configuration and functional blocks of each power supply according to the embodiment of the present invention.

FIG. 5 is a diagram describing an example of the data structure and data contents of VM power management data in the power supply according to the embodiment of the present invention.

FIG. 6 is an example of a screen for registering virtual hosts in the case of the power supply according to the embodiment of the present invention.

FIG. 7 is an example of a screen for registering power information on each VM in the case of the power supply according to the embodiment of the present invention.

FIG. 8 is a diagram describing an example of the data structure and data contents of power setting policy data in the power supply according to the embodiment of the present invention.

FIG. 9 is a diagram describing the relation between a stop time of the power supply and a shutdown of each VM and its virtual host, in the case of the power supply according to the embodiment of the present invention.

FIG. 10 is a flowchart describing processing of a VM power data transfer unit in the migration source power supply according to the embodiment of the present invention.

FIG. 11 is a flowchart describing processing of the VM power data transfer unit in the migration destination power supply according to the embodiment of the present invention.

FIG. 12 is a flowchart describing processing of a power setting policy checking unit in the migration destination power supply according to the embodiment of the present invention.

FIG. 13 is a sequence diagram describing an outline of the control method according to a modification of the present invention.

FIG. 14 is a diagram describing an example of the hardware configuration and functional blocks of a power management apparatus according to the modification of the present invention.

FIG. 15 is a diagram describing an example of the data structure and data contents of the VM power management data of the power management apparatus according to the modification of the present invention.

### DETAILED DESCRIPTION OF THE PREFERRED EMBODIMENTS

Embodiments of the present invention will be described next with reference to the drawings. In the following description of the drawings, the same or similar portions are denoted by the same or similar reference signs.

First of all, in the embodiments of the present invention, a “physical computer” is a general computer including a central processing unit (CPU), a storage device, and the like. Specifically, a “physical computer” is a computer such as a personal computer, a server, or a blade server. Moreover, a “virtual host computer (virtual host)” is implemented on a physical computer by executing a host OS on the physical computer. One virtual host can run one or more VMs. A “VM” is a virtual computer obtained by emulating another computer as software on one virtual host.

A “virtual system” includes a physical computer, a physical storage, a physical switch, a physical network, and the like. The whole virtual system functions as one or more VMs and virtual storages. “Virtualization management” manages virtual infrastructures constructing a virtual system and controls the running of one or more VMs.

Commands for a virtual host include “shutdown,” “reboot,” “power on,” “power off,” and the like. “Shutdown” is to cause a virtual host OS running on a physical computer to transition to a state where power feed to the virtual host OS can be stopped through a predetermined procedure. “Reboot” is to shut down and boot again a virtual host OS running on a physical computer through a predetermined procedure. “Power on” is to power on a physical computer that runs a virtual host, and to run a virtual host OS.

Commands for a VM include “shutdown,” “reboot,” “power on,” “power off,” and the like. “Shutdown” is to cause a guest OS installed in a VM to transition to a state where resources such as a CPU and a memory allocated to the VM can be freed. “Reboot” is to shut down and boot a VM again. “Power on” is to use resources such as a CPU and a memory allocated to a VM so as to run this VM. “Power off” is to free resources such a CPU and a memory allocated to a VM. Meanwhile, if a shutdown of a VM does not end normally, a “power off” may be performed for a force-quit.

A “power supply” is an apparatus configured to feed power to virtual infrastructures, as well as to measure and cut the power. Specifically, a “power supply” is an alternating current (AC) power supply, a direct current (DC) power supply, an uninterruptible power supply (UPS), a power distribution unit (PDU), or the like.

A “virtual power source” is a source of power necessary for a CPU and a memory to run a VM in a virtual host computer. A virtual power source is a power source that feeds a part of power, fed from a physical power supply to its virtual host, for use in a given VM.

“Power management” is control that allows stable feed of power to infrastructures. Power management in the embodiments of the present invention refers to such a function that a power supply automatically shuts down infrastructures such as computers to protect the services and data of the computers in the event of inspection of power equipment or a power fault.

A “delay time to stop” is a period of time from when a power supply generates a trigger to stop power feed to when a VM run in emulation by a virtual host fed with power from this power supply starts to shut down. A “shutdown time” is a period of time required for a virtual host computer or a VM run in emulation by this virtual host computer to power off after the start of its shutdown. Here, the virtual host computer shuts down after the shutdown of all the VMs run in emulation by the virtual host computer is complete.

The “trigger to stop power feed” is (1) a timing at which the power supply starts a shutdown of each virtual host and each VM after the elapse of a shutdown waiting time of the power supply since the occurrence of a power failure, (2) a timing at which the time is reaches a scheduled stop time set for scheduled operation or the like, (3) a timing at which a command to shut down the power supply is received from a remote terminal, (4) a timing at which a shutdown command inputted by the administrator through a power operating panel or the like is received, or the like.

### (Virtual System)

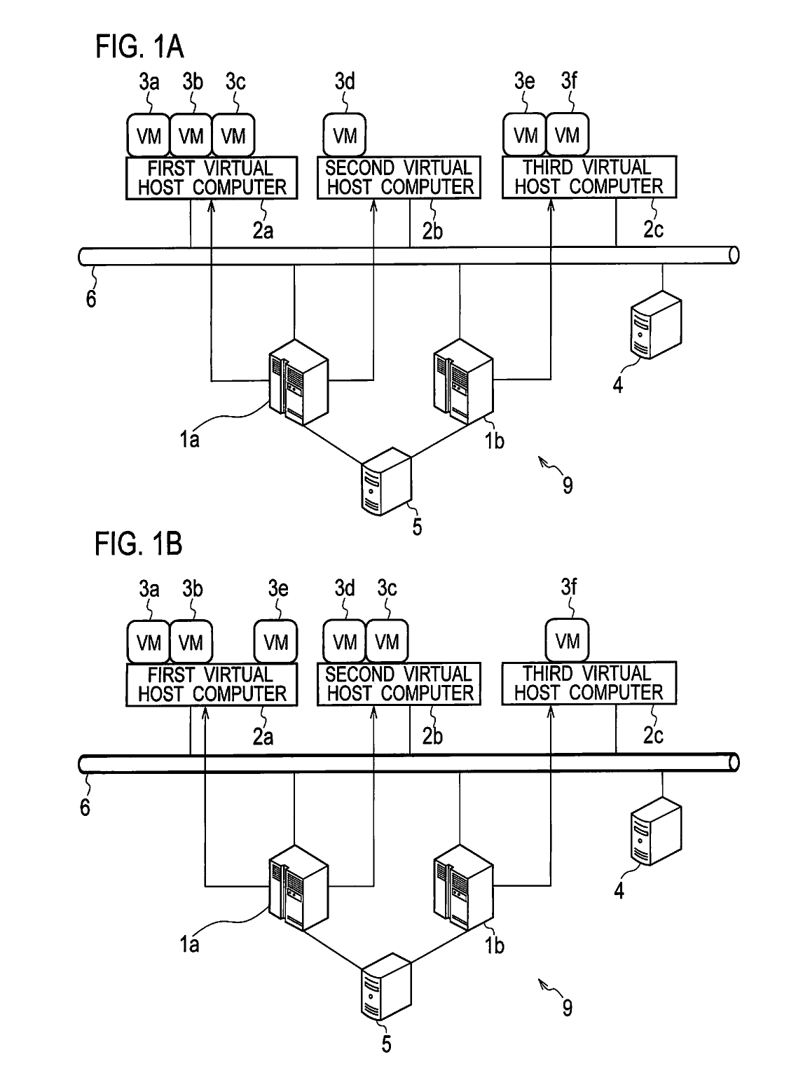

Referring to FIG. 1A, description will be given of a virtual system 9 according to an embodiment of the present invention. The virtual system 9 includes a first power supply 1a, a second power supply 1b, a first virtual host computer 2a, a second virtual host computer 2b, a third virtual host computer 3c, a first VM 3a, a second VM 3b, a third VM 3c, a fourth VM 3d, a fifth VM 3e, a sixth VM 3f, a virtualization management server 4, and a power management apparatus 5. The first power supply 1a, the second power supply 1b, the first virtual host computer 2a, the second virtual host computer 2b, the third virtual host computer 3c, the first VM 3a, the second VM 3b, the third VM 3c, the fourth VM 3d, the fifth VM 3e, the sixth VM 3f, and the virtualization management server 4, are connected by a communication network 6 in such a way as to be capable of mutual communications. The example shown in FIG. 1A describes a case where the power management apparatus 5 is connected to first power supply 1a and the second power supply 1b in such a way as to be capable of mutual communications. However, the power management apparatus 5 may be connected to the other apparatuses by the communication network 6 in such a way as to be capable of communications.

In this embodiment, the first virtual host computer 2a, the second virtual host computer 2b, and the third virtual host computer 3c may sometimes be described simply as virtual host computer(s) 2 when they are not distinguished from each from one another. Moreover, the virtual host computer(s) 2 may sometimes be described simply as virtual host(s) 2. The first VM 3a, the second VM 3b, the third VM 3c, the fourth VM 3d, the fifth VM 3e, and the sixth VM 3f may sometimes be described simply as VM(s) 3 when they are not distinguished from one another. The numbers of power supplies 1, virtual host computers 2, VMs 3, etc. are mere examples and are not limited to these examples.

The virtual system 9 shown in FIG. 1A includes multiple virtual host computers 2, and each of these virtual host computers 2 is configured to run one or more VMs 3 in emulation. Here, each virtual host computer 2 is a physical computer constituting a physical infrastructure. Each VM 3 is a virtual computer constituting a virtual infrastructure run in emulation by a virtual host computer 2.

Each virtual host 2 is implemented by installing a given program in a general physical computer. The virtual host 2 is configured to run a VM(s) 3 in emulation. In FIG. 1A, the first virtual host 2a runs the first VM 3a, the second VM 3b, and the third VM 3c in emulation; the second virtual host 2b runs the fourth VM 3d in emulation; the third virtual host 2c runs the fifth VM 3e and the sixth VM 3f in emulation.

In the virtual system 9 shown in FIG. 1A, the power supply 1 is configured to feed power to the virtual host computer 2 running the VM 3 in emulation, the VM 3 controlled by the virtualization management server 4. Further, the power supply 1 is configured to manage the virtual power source of the VM 3 run in emulation by the virtual host 2. The targets of the power feed of the first power supply 1a are the first virtual host 2a and the second virtual host 2b, and the first power supply 1a therefore manages the virtual power sources of the first VM 3a, the second VM 3b, the third VM 3c, and the fourth VM 3d. The target of the power feed of the second power supply 1b is the third virtual host 2c, and the second power supply 1b therefore manages the virtual power sources of the fifth VM 3e and the sixth VM 3f.

The power management apparatus 5 is a computer configured to operate the power supplies 1. The power management apparatus 5 is implemented by a general computer executing a predetermined program. The power management apparatus 5 is configured to input commands to the power supplies 1, display information on the power supplies 1, and perform data processing related to input and output of the commands and information.

The virtualization management server 4 is configured to execute virtualization management of the VMs 3 shown in FIG. 1A such as migration and resource allocation. Here, in the embodiment of the present invention, it is not the virtualization management server 4 but the power supplies 1 that control virtual power sources for a boot and shutdown of the VMs.

Description will be given of the virtual system 9 in which VMs 3 have been migrated by the virtualization management server 4. In the virtual system 9 shown in FIG. 1B, the third VM 3c and the fifth VM 3e have been migrated. The third VM 3c is run in emulation by the first virtual host 2a in FIG. 1A but is run in emulation by the second virtual host 2b in FIG. 1B. The fifth VM 3e is run in emulation by the third virtual host 2c in FIG. 1A but is run in emulation by the first virtual host 2a in FIG. 1B. The embodiment of the present invention assumes that the virtualization management server 4 instructs the migration of these VMs 3.

Upon migration of a VM as shown in FIGS. 1A and 1B, the power supply 1 according to the embodiment of the present invention transfers information on the virtual power source of this virtual machine to the power supply that feeds power to the migration destination virtual host computer. Thus, the power supply 1 can perform such control that the ability of the power supply that feeds power to the migration destination virtual host computer 2 matches a value set to the virtual power source of the VM 3. This contributes to improvement of the reliability of the virtualization management.

### (Control Method)

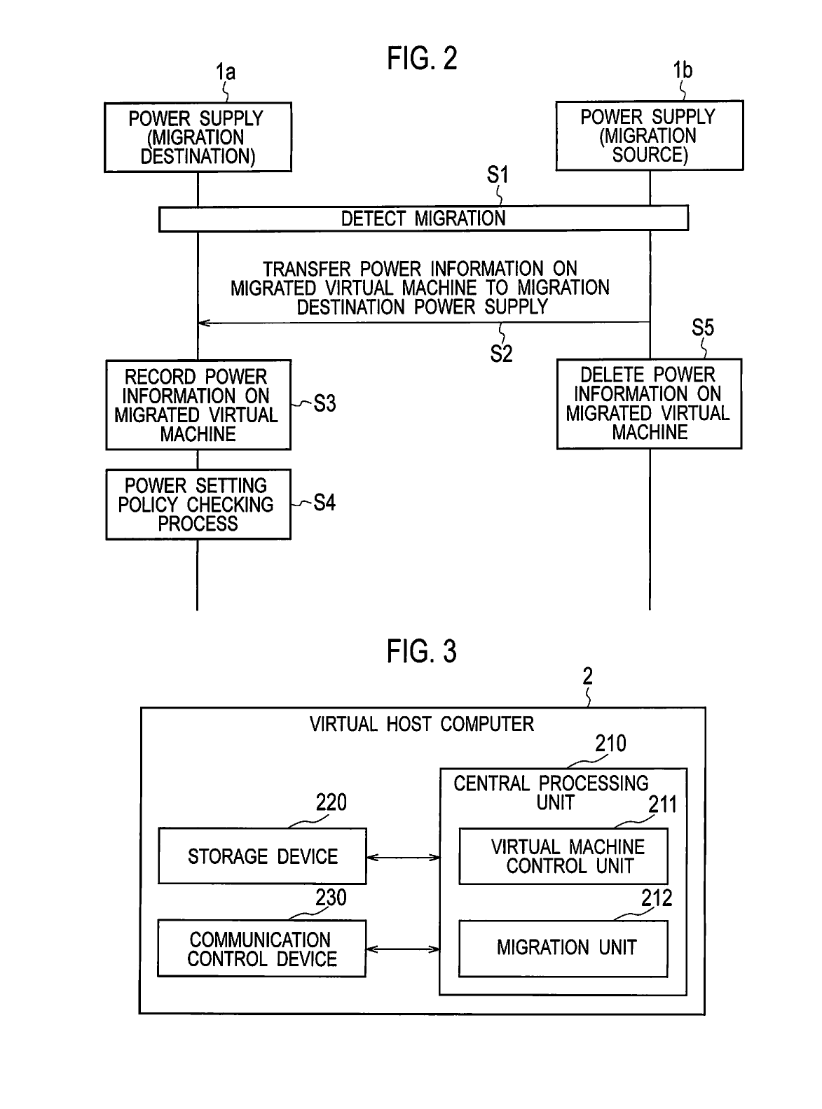

Referring to FIG. 2, description will be given of a control method of the virtual system 9 according to the embodiment of the present invention. FIG. 2 describes a case where the virtualization management server 4 migrates the fifth VM 3e from the third virtual host 2c to the first virtual host 2a. Here, the first power supply 1a feeds power to the first virtual host 2a, while the second power supply 1b feeds power to the third virtual host 2c.

In step S1, the first power supply 1a and the second power supply 1b detect that the fifth VM 3e has been migrated from the third virtual host 2c to the first virtual host 2a under the control of the virtualization management server 4. In this event, the first power supply 1a and the second power supply 1b may detect the migration by inquiring of each virtual host 2 about each VM 3 run in emulation by the virtual host 2. Alternatively, the first power supply 1a and the second power supply 1b may detect the migration of the fifth VM 3e through a notification of the migration from the virtualization management server 4. In the embodiment of the present invention, the manner in which the first power supply 1a and the second power supply 1b detect migration of a VM 3 is not particularly limited.

When the first power supply 1a and the second power supply 1b detect the migration of the fifth VM 3e, power information thereon is transferred between the power supplies 1 in step S2. Specifically, the second power supply 1b that feeds power to the third virtual host 2c being the migration source transfers the power information on the migrated fifth VM 3e by sending the power information to the first power supply 1a that feeds power to the first virtual host 2a being the migration destination. In step S3, the first power supply 1a stores the power information on the fifth VM 3e received in step S2. Meanwhile, the first power supply 1a may store the latest version of the power information on the fifth VM 3e in advance and, if this power information is disabled, enable the power information. Here, in the case where the disabled power information is not the latest version, the first power supply 1a stores the latest version of the power information on the fifth VM 3e. In step S4, the first power supply 1a determines whether or not the power information on the fifth VM 3e matches the power setting policy of the first power supply 1a.

On the other hand, once transferring the power information on the fifth VM 3e to the first power supply 1a in step S2, the second power supply 1b deletes the power information on the fifth VM 3e out of the memory of the second power supply 1b in step S5. In this event, the second power supply 1b may not delete but disable the power information on the fifth VM 3e.

As described above, in the virtual system 9 controlled by the virtualization management server 4, each power supply 1 according to the embodiment of the present invention holds the power information on the VM 3 run in emulation by the virtual host 2 fed with power from the power supply 1. Moreover, when a VM 3 is migrated, the power information on the VM 3 is transferred between the power supplies 1 in response to this migration. Furthermore, the migration destination power supply 1 determines whether or not the power information on the migrated VM 3 matches the policy of the migration destination power supply 1. If the power information does not match the policy, the migration destination power supply 1 notifies of an alerter indicating that fact. In this way, it is possible to change the power information on the VM 3 in accordance with the policy of the power supply 1 or to prompt migration to a power supply 1 that has a policy matching the power information on the VM 3.

Here, the power setting policy is a policy for the power supply 1 to feed power such that each virtual host 2 fed with power from the power supply 1 or each VM 3 run in emulation by this virtual host 2 can run stably. The power setting policy is a condition as to whether states of hardware and software included in the power supply 1 satisfy settings related to start and stop of the running of each virtual host 2 and each VM 3 thereof.

According to the embodiment of the present invention as described above, it is possible to prompt the system administrator in the event of a power failure or the like such that the power supply 1 can sufficiently feed power until each VM 3 and each virtual host 2 thereof shut down. Moreover, even if a VM 3 is newly migrated to a virtual host 2 fed with power from a power supply 1 experiencing a malfunction or power failure, it is possible to prompt migration of the migrated VM 3 to a different virtual host 2. As described above, by combining the power information on each VM 3 and the power feed of each power supply 1, it is possible to improve the reliability of the virtual system 9.

### (Virtual Host Computer)

Referring to FIG. 2, description will be given of each virtual host computer 2 according to the embodiment of the present invention. Each virtual host computer 2 is a general computer including a central processing unit 210, a storage device 220, and a communication control device 230. A host OS for controlling VMs is installed in the virtual host computer 2. The storage device 220 may be formed of multiple storage devices. Likewise, the central processing unit 210 may be formed of multiple central processing units as well. Further, the storage device 220 may be a shared disk to which multiple virtual host computers can be connected.

The storage device 220 is a storage medium configured to store data related to processing in the central processing unit 210, and is a hard disk drive, for example. The communication control device 230 is a device configured to communicate with other computers and power supplies, a shared disk, and so on, and is an LAN adaptor, a fibre-channel SAN (FC-SAN), or the like, for example.

By the installation of the host OS or the like, the central processing unit 210 implements a VM control unit 211 and a migration unit 212.

The VM control unit 211 is a unit configured to control each VM 3 run in emulation by the virtual host computer 2. The VM control unit 211 controls each of the VMs 3 through allocation of resources to the VMs 3 and the like, for example. In the embodiment of the present invention in particular, the VM control unit 211 controls migration of the VMs 3 in accordance with instructions from the virtualization management server 4.

The migration unit 212 is a unit configured to migrate a VM 3 to a different virtual host computer 2. In the embodiment of the present invention, the migration unit 212 migrates a VM 3 on the basis of a migration request inputted from the virtualization management server 4. The embodiment of the present invention is not particularly limited about its specific means for controlling and migrating a VM 3.

### (Power Supply)

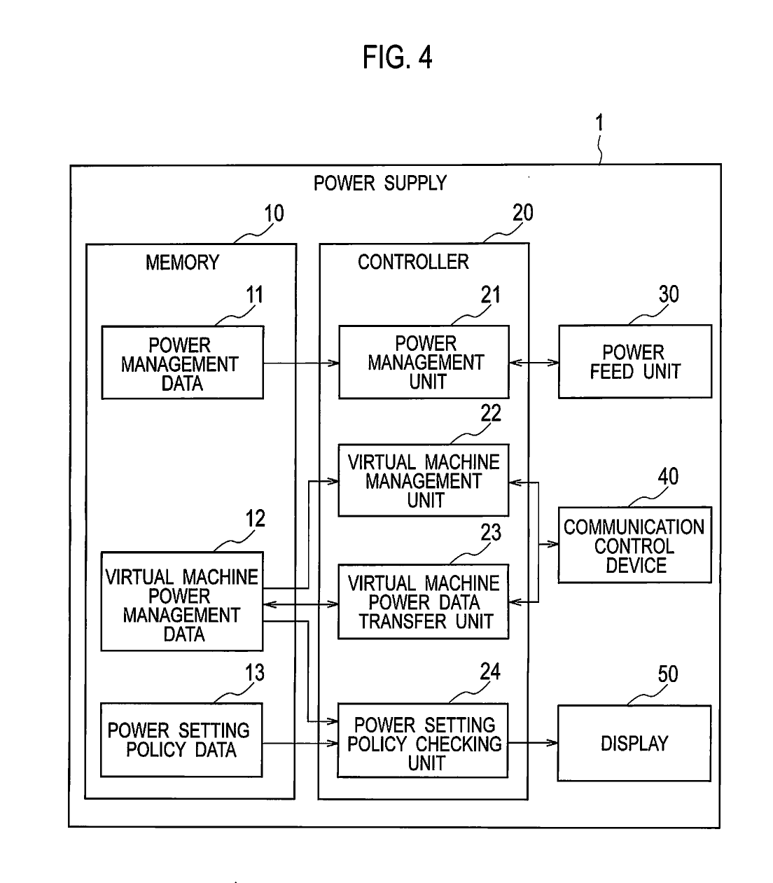

Referring to FIG. 4, description will be given of each power supply 1 according to the embodiment of the present invention. The power supply 1 includes a memory 10, a controller 20, a power feed unit 30, and a communication control device 40.

The power feed unit 30 is configured to feed power to each virtual host computer 2 connected to the power supply 1. The power feed unit 30 includes multiple outlets and is capable of feeding power to multiple virtual host computers 2. In the example shown in FIG. 1A, the first power supply 1a includes at least two outlets, and the second power supply 1b includes at least one outlet.

The communication control device 40 is a device configured to communicate with other power supplies and information apparatuses, and is an LAN adapter, for example. In the example shown in FIG. 1A, the communication control device 40 is capable of mutual communications with the virtual hosts 2 via the communication network 6, and is also capable of mutual communications with the power management apparatus 5.

The memory 10 is a storage device configured to accumulate: program data of a firmware program and the like that are executed on the power supply 1; data to be processed by the controller 20; and the like. The memory 10 has a storage area for the program data and also stores power management data 11, VM power management data 12, and power setting policy data 13. The embodiment of the present invention will describe a case where the memory 10 of the power supply 1 stores the pieces of data; however, these pieces of data are not necessarily stored in the memory 10 incorporated in the power supply 1. For example, the pieces of data may be stored in an external storage unit such as a computer's hard disk drive or semiconductor memory from which the power supply 1 can read data.

The power management data 11 is data storing setting information on power to be fed to each virtual host 2. In the power management data 11, an identifier of each outlet, an identifier of the virtual host 2 to which power is fed from that outlet, setting information for that power feed, and a shutdown time are associated with each other. The “shutdown time” is a period of time required to shut down the virtual host 2. The actual shutdown time varies depending upon the running environment of the virtual host 2. Thus, a period of time expected to be required for a shutdown is set in the power management data 11. The shutdown time may be set by the user. Moreover, the “setting information for that power feed” is the type of power feed, input voltage, input frequency, output voltage, output frequency, etc. However, these are mere examples, and other information may be contained.

The VM power management data 12 is data in which an identifier of the VM 3 run in emulation by the virtual host 2 fed with power from the power supply 1, and the power information on the VM 3 are associated with each other. The VM power management data 12 is data acquired by a VM power management data transfer unit 23 described later.

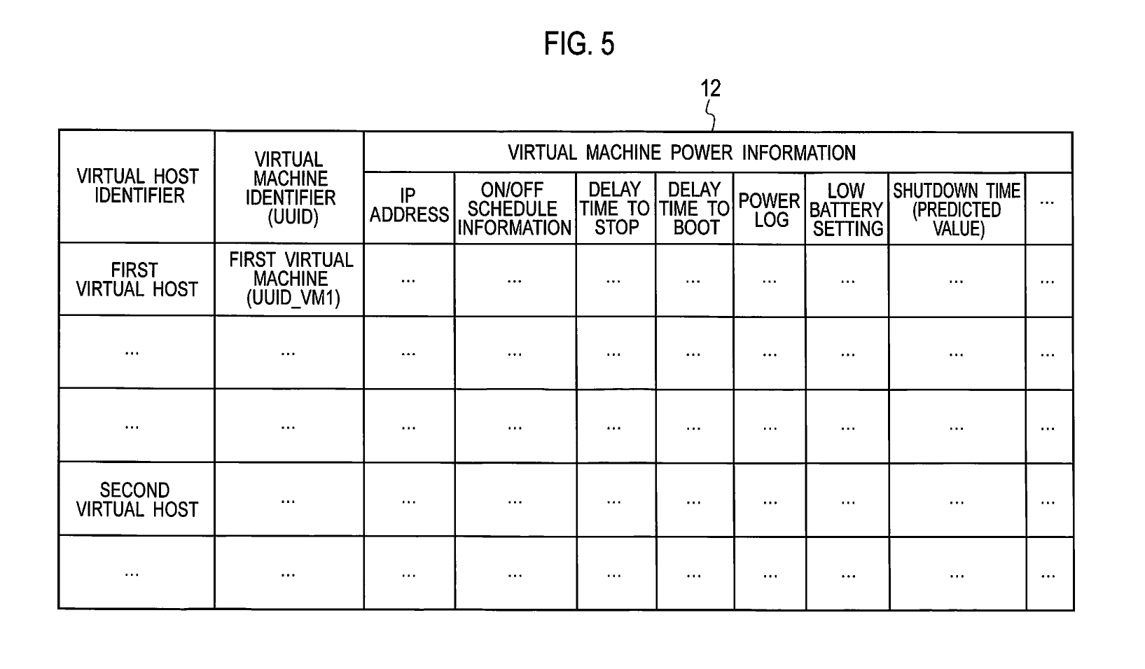

The VM power management data 12 is data shown in FIG. 5, for example. The VM power management data 12 shown in FIG. 5 is data in which a virtual host identifier of each virtual host 2 fed with power from the power supply 1, a VM identifier of each VM 3 run in emulation by this virtual host 2, and VM power information on this VM 3 are associated with each other.

The virtual host identifier is the machine name, IP address, or the like of the virtual host 2. The VM identifier is the machine name, IP address, UUID, or the like of the VM 3.

The VM power information is information on the virtual power source of the VM 3 about start and stop of the running of the VM 3, and is information related to the power feed of the power supply 1. For example, the VM power information is the IP address, ON/OFF schedule information, delay time to stop, delay time to boot, power log, low battery setting, shutdown time, etc. of the VM 3. Here, the “ON/OFF schedule information” is a scheduled time to boot or shut down the VM 3. The “power log” is a log related to the virtual power source such as a boot and shutdown of the VM 3. The “low battery setting” specifies a command such as a shutdown or boot in safe mode which the VM 3 executes when the amount of charge in the power supply 1 becomes low. In the embodiment of the present invention, the power supply 1 transfers the power information on the VM 3 when that VM 3 is migrated. The “shutdown time” is a period of time required to shut down the VM 3. The actual shutdown time varies depending upon the running environment of the VM 3. Thus, a period of time expected to be required for a shutdown is set in the VM power management data 12. This shutdown time may be set by the user.

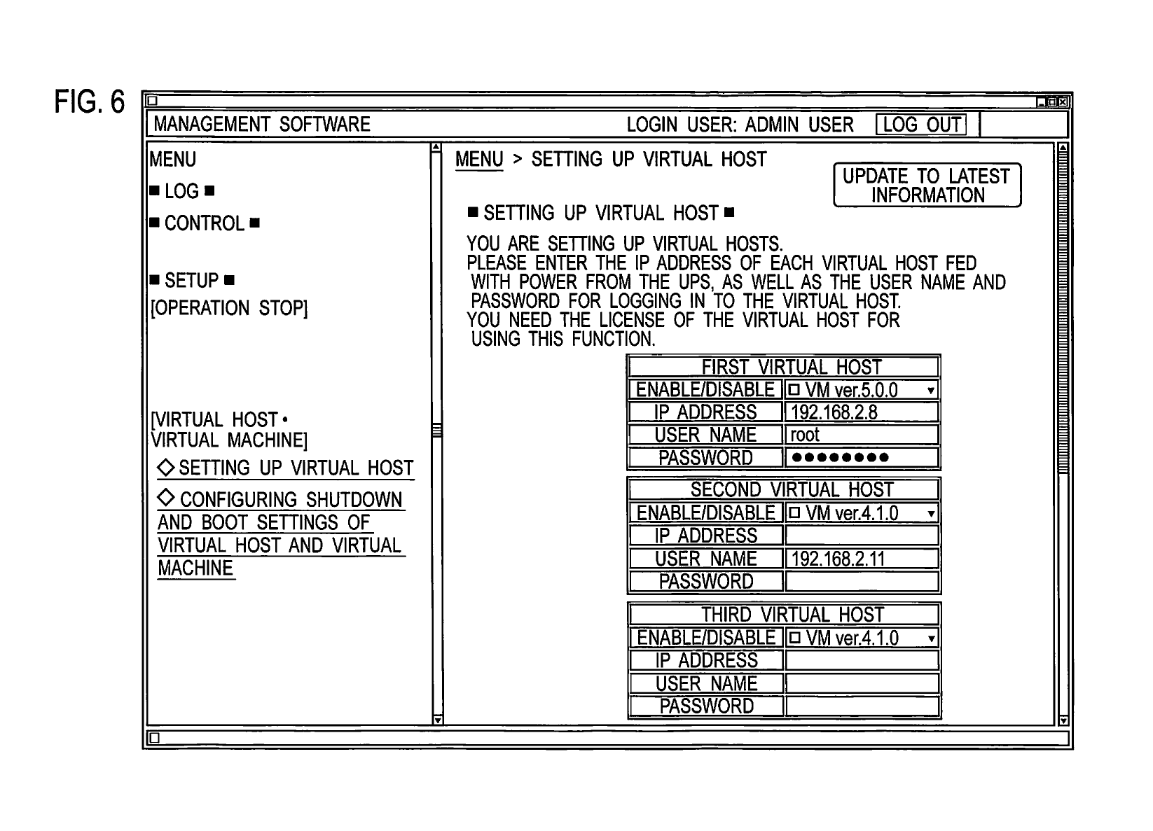

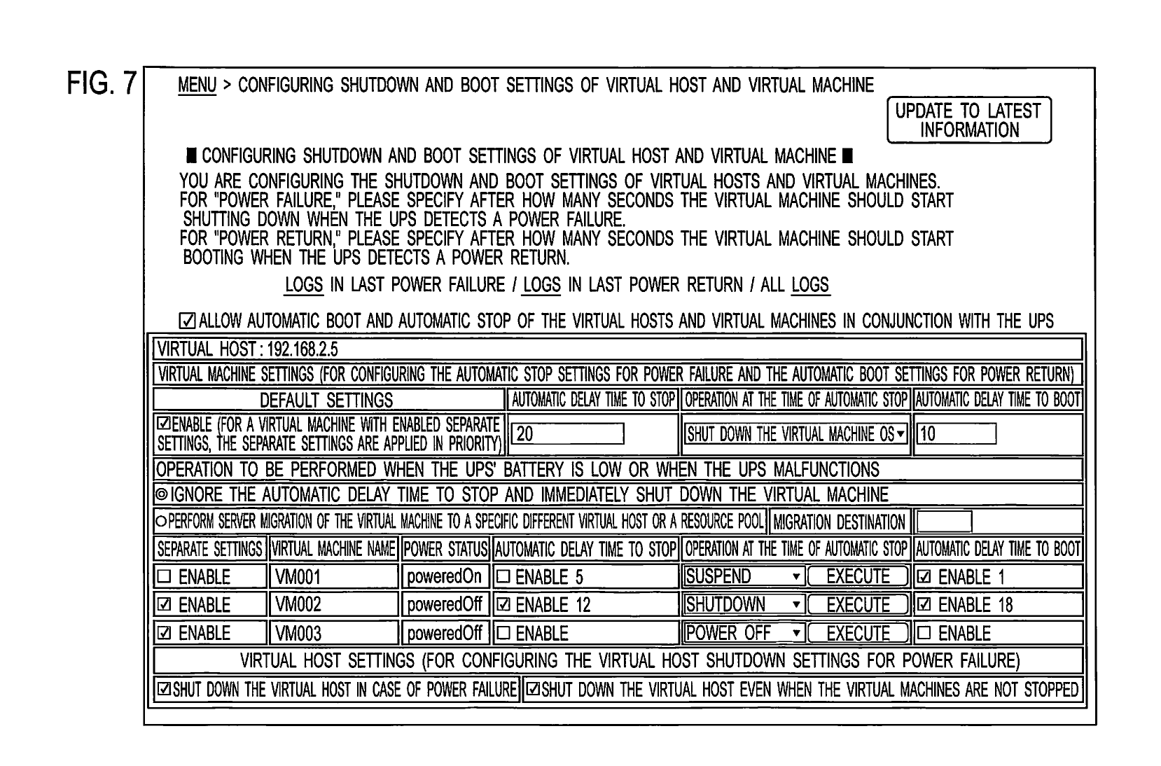

Meanwhile, when a power supply 1 is newly installed or when a virtual host 2 or VM 3 is installed, the VM power management data 12 is set in advance through screens shown in FIGS. 6 and 7 or the like. In the VM power management data 12, the virtual host identifier may be input in advance by the user through the screen shown in FIG. 6 or the like, for example. FIG. 6 is a screen in which the user inputs the information on each virtual host 2 to be fed with power from the power supply 1. The screen shown in FIG. 6 may be displayed on a display of the power supply 1 or displayed on a display of the power management apparatus 5 connected to the power supply 1.

The user inputs the IP address, user name, and password of each virtual host 2 in the screen shown in FIG. 6. The power supply 1 acquires the information inputted in the screen shown in FIG. 6 and sets the information on the virtual host in the VM power management data 12.

Moreover, in the VM power management data 12, the power information on each virtual machine may be inputted in advance by the user through the screen shown in FIG. 7 or the like. FIG. 7 is a screen in which the user inputs the information on the VM run in emulation by the virtual host 2 fed with power from the power supply 1. The screen shown in FIG. 7 may be displayed on the display of the power supply 1 or displayed on the display of the power management apparatus 5 connected to the power supply 1.

In the screen shown in FIG. 7, the user sets information related to the virtual power source of each VM 3 such as the delay time to stop, operation at the time of stop, and boot delay time thereof. The user may set default power information on the VM 3 or set individually selected power information on the virtual machine 3. The power supply 1 acquires the information inputted in the screen shown in FIG. 7 and sets the power information on the VM in the VM power management data 12.

The power setting policy data 13 is data containing a condition that allows the power supply 1 to feed power for running the VMs 3. Specifically, in the case where a new VM is migrated to the virtual host 2 fed with power from the power supply 1, the power setting policy data 13 is data related to the migration of this new VM and containing a condition necessary for the power supply 1 to feed power to the new VM and the virtual host 2 which runs the new VM in emulation.

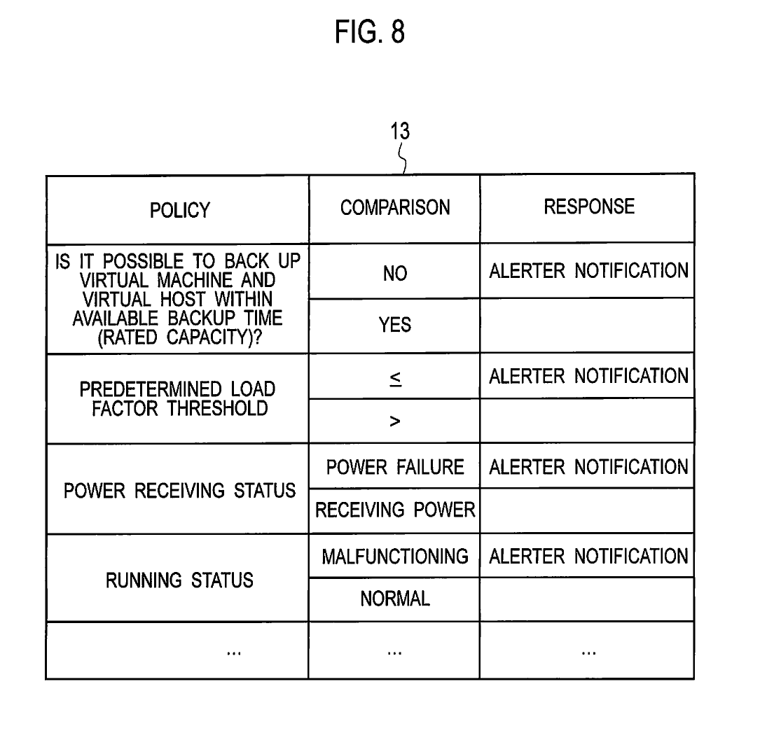

The power setting policy data 13 is data shown in FIG. 8. The power setting policy data 13 shown in FIG. 8 is data in which each policy item for checking match, a comparison condition for that policy, and a response of the power supply 1 when it is determined from that comparison that there is not a matching result.

The power setting policy data 13 is data set in advance by the system administrator or the like in accordance with the ability and state of the power supply 1.

For example, a policy about an available backup time is a possible policy item. This available backup time is a period of time for which power can be fed for backup after a power failure occurs, and is calculated from a battery's rated voltage, temperature, running time, the battery's internal resistance, load factor, etc. According to the power setting policy data 13, each virtual host 2 and each VM 3 all need to be powered off within this available backup time.

The power setting policy data 13 correspondingly holds a condition that allows power off of the virtual host 2 and the VM 3 within the available backup time. If a shutdown of these devices does not complete within the available backup time, the power supply 1 notifies the system administrator or the like of an alerter. In this way, it is possible to prompt migration of the VM 3 to a virtual host 2 fed with power from a different power supply 1, or to prompt reviewing of the settings of the virtual power source of the VM 3.

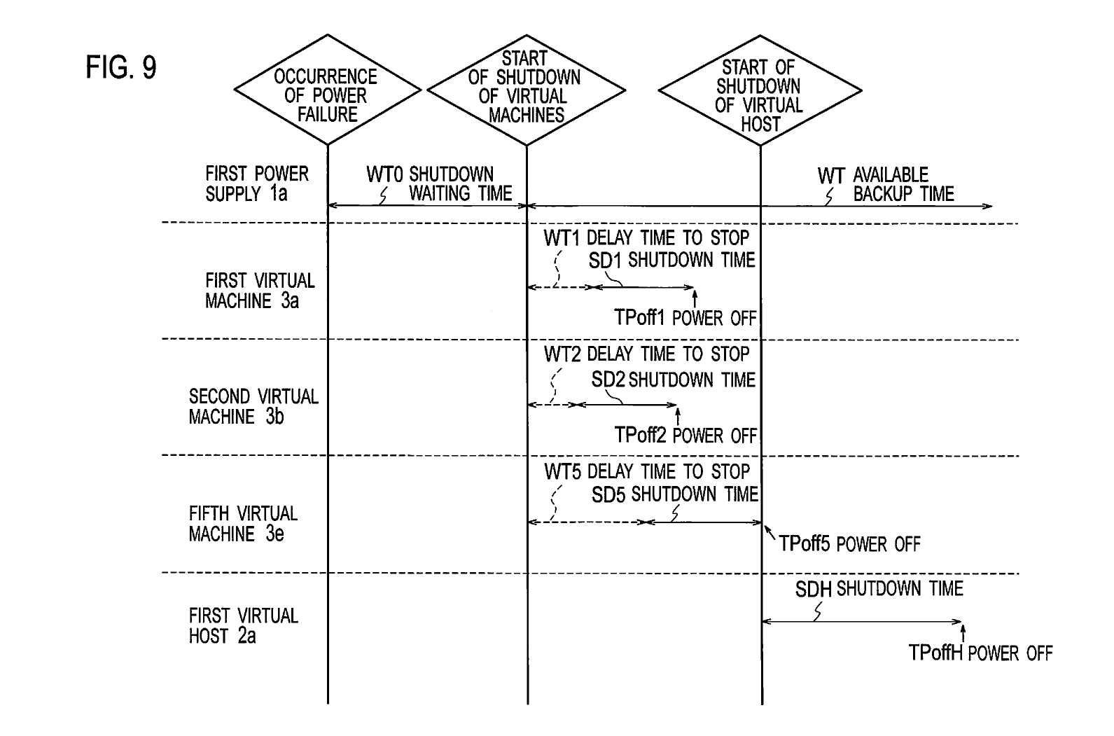

Referring to FIG. 9, description will be given of the flow of a shutdown of the VMs 3 and the virtual host 2 due to the power supply 1 experiencing a power failure. In the example shown in FIG. 9, time flows from left to right. In the following, described is a case based on FIG. 1B where the first virtual host 2a which the first power supply 1a feeds power to is to be shut down. The first virtual host 2a must be shut down after the first VM 3a, the second VM 3b, and the fifth VM 3e are shut down.

First, when the power failure occurs, the first power supply 1a starts to feed power to the first virtual host 2a and waits a shutdown waiting time WT0 for a power return. If the power returns within the shutdown waiting time WT0, a shutdown of the first virtual host 2a and the VMs 3 will not be started. If the power does not return, the first power supply 1a starts a shutdown of the first virtual host 2a and the VMs 3 after the elapse of the shutdown waiting time WT0.

Each of the VMs 3 is given a delay time to stop as described above with reference to FIG. 5. Thus, each VM 3 starts to shut down after the elapse of its delay time to stop.

After waiting a delay time to stop WT1, the first VM 3a starts to shut down and, after completing the shutdown at a time TPoff1, the first VM 3a powers off. After waiting a delay time to stop WT2, the second VM 3b starts to shut down and, after completing the shutdown at a time TPoff2, the second VM 3b powers off. After waiting a delay time to stop WT5, the fifth VM 3e starts to shut down and, after completing the shutdown at a time TPoff5, the fifth VM 3e powers off. Once the shutdown of all of these VMs 3 is confirmed, the first virtual host 2a starts to shut down. Thus, the first power supply 1a must feed power from the occurrence of the power failure until the completion of the shutdown of the first virtual host 2a.

Here, in the example shown in FIG. 9, a period of time for which the first power supply 1a can feed power after the elapse of the shutdown waiting time WT0 is referred to as an available backup time WT. The available backup time WT is calculated in advance based on the period of time for which the power supply 1 can output power and the shutdown waiting time WT0. The power supply 1 determines whether or not power off of all the VMs 3 and the first virtual host 2a can be complete within the available backup time WT. In this determination, the time required for the shutdown of each VM 3 uses a predicted value of the shutdown time set in the VM power management data 12. Moreover, the time required for the shutdown of the first virtual host 2a uses a predicted value of the shutdown time of the first virtual host 2a in the power management data 11.

For instance, in the example shown in FIG. 9, the power off time TPoff5 of the fifth VM 3e is the latest power off timing among the first VM 3a, the second VM 3b, and the fifth VM 3e. Thus, the shutdown start time of the first virtual host 2a is restrained by the power off timing of the fifth VM 3e.

Specifically, suppose that the sum of the delay time to stop WT5 and a shutdown time SD5 of the fifth VM 3e which is newly migrated is shorter than those of the other first and second VMs 3a and 3b. This case is not problematic because the newly migrated fifth VM 3e is not a bottleneck that delays the start of the shutdown of the first virtual host 2a. On the other hand, when the sum of the delay time to stop WT5 and the shutdown time SD5 of the newly migrated fifth VM 3e is longer than those of the other first and second VMs 3a and 3b, the fifth VM 3e is a bottleneck. Consequently, the start of the shutdown of the first virtual host 2a is delayed, thereby causing a possibility that the first virtual host 2a will not finish shutting down within the available backup time WT.

Thus, in the case where the newly migrated fifth VM 3e has the greatest sum of the delay time to stop and the shutdown time among those of the VMs 3 run in emulation by the first virtual host 2a, the power supply 1 calculates the sum of the delay time to stop WT5 and the shutdown time SD5 of the fifth VM 3e and a shutdown time SDH of the first virtual host 2a. If this sum exceeds the available backup time WT, the power supply 1 notifies the system administrator or the like of an alert.

While the example shown in FIG. 9 has described the case where the first power supply 1a feeds power to only the first virtual host 2a, the same applies to cases where the first power supply 1a feeds power to multiple virtual hosts 2. In such cases, the first power supply 1a calculates, for each virtual host 2, the time taken to complete a shutdown of this virtual host 2, and determines, for every virtual host, whether or not its shutdown completes within the available backup time WT.

Moreover, as shown in FIG. 8, the power setting policy data 13 may contain data for determining whether or not to notify of an alerter that is based on only a setting or state of the power supply 1. For example, when the power supply 1 is not in such a state as to be able to sufficiently feed power, the power setting policy is considered to be not met, and an alerter can be notified of. When the power supply 1 is not able to sufficiently feed power refers to a situation where the load factor of the power supply 1 is higher than a predetermined threshold, a situation where the power receiving status of the power supply 1 is “power failure,” a situation where the running status of the power supply 1 is “malfunctioning,” or the like.

The example of the power setting policy data 13 shown in FIG. 8 has described the case where the system administrator is notified when the setting policy of the power supply 1 is violated. However, the present invention is not limited to this case. For example, the virtualization management server 4 may be notified of the violation, and the virtualization management server 4 may migrate the VM 3 to a virtual host 2 fed with power from a different power supply 1. Alternatively, the power supply 1 may migrate the VM 3. There are various other possible processes as well.

The controller 20 includes a power management unit 21, a VM management unit 22, a VM power data transfer unit 23, and a power setting policy checking unit 24. The controller 20 is configured to control processing of each of these units. The controller 20 is a so-called embedded computer and differs from a CPU used in general computers.

The power management unit 21 is configured to control the feed of power to the virtual hosts 2 by instructing the power feed unit 30 on the basis of the power management data 11. The power management unit 21 feeds power by following a condition set in advance for each outlet. Moreover, during a normal state, the power management unit 21 is supplied with power from an external power source to charge a storage battery and feeds power to each outlet. In the event of a power failure, the power management unit 21 feeds power to each outlet from the storage battery.

The VM management unit 22 is configured to control processing related to the power source of the VM 3 run in emulation by the virtual host 2 fed with power from the power supply 1, on the basis of the VM power management data 12. In the case of the first power supply 1a in FIG. 1A, the management targets of the VM management unit 22 are the first VM 3a, the second VM 3b, and the third VM 3c run in emulation by the first virtual host 2a, and the fourth VM 3d run in emulation by the second virtual host 2b.

The VM management unit 22 according to the embodiment of the present invention may refer to the VM power management data 12 and input a command related to the virtual power source of the VM 3. The command related to the virtual power source of the VM 3 includes a command related to a resource necessary for running the VM 3 such as a boot, shutdown, power on, or power off of the VM 3. The VM management unit 22 sends a command to boot or shut down the VM 3 to the virtual host 2 or the VM 3 on the basis of the ON/OFF schedule set in the VM power management data 12.

Note that in the embodiment of the present invention, the VM management unit 22 may send a command such as a “shutdown,” “power on,” or “power off” to the VM 3. In this case, the VM management unit 22 reads the VM power management data 12 and sends a command to the virtual host 2 on the basis of the delay time to stop, the ON/OFF schedule information, etc. specified in the power information on the VM 3. Upon receipt of the command from the power supply 1, the virtual host 2 controls the VM 3 on the basis of the command.

Alternatively, in another example, the power supply 1 may not send a command such as a “shutdown,” “power on,” or “power off.” In this case, in the event of a power failure or the like, the power management unit 21 of the power supply 1 sends a shutdown command to the virtual host 2. Upon receipt of the shutdown command from the power supply 1, the virtual host 2 shuts down each VM 3 in accordance with the power information on the VM 3 and then shuts itself down.

When the virtualization management server 4 migrates a VM 3 run in emulation by the virtual host computer 2 fed with power from the power supply to a migration destination virtual host computer fed with power from a different power supply, the VM power data transfer unit 23 extracts the power information on the migrated VM out of the VM power management data 12 and transfers it to the different power supply. Moreover, when a new VM is migrated and to be run in emulation, the VM power data transfer unit 23 acquires the power information on this new VM and stores it in the VM power management data 12.

Specifically, suppose that the virtualization management server 4 has migrated the fifth VM 3e run in emulation by the third virtual host 2c fed with power from the second power supply 1b to the first virtual host 2a fed with power from the first power supply 1a. In this case, the second power supply 1b transfers the power information on the fifth VM 3e to the first power supply 1a. Upon receipt of the power information on the fifth VM 3e, the first power supply 1a stores it in the VM power management data 12.

The VM power data transfer unit 23 of the power supply 1 according to the embodiment of the present invention, upon migration of a VM 3, transfers the power information on this VM 3 to the power supply 1 feeding power to the virtual host 2 to which the VM 3 is migrated. Thus, in the case where a VM 3 is migrated over a network segment such as a data center or a server room, its power information is similarly transferred.

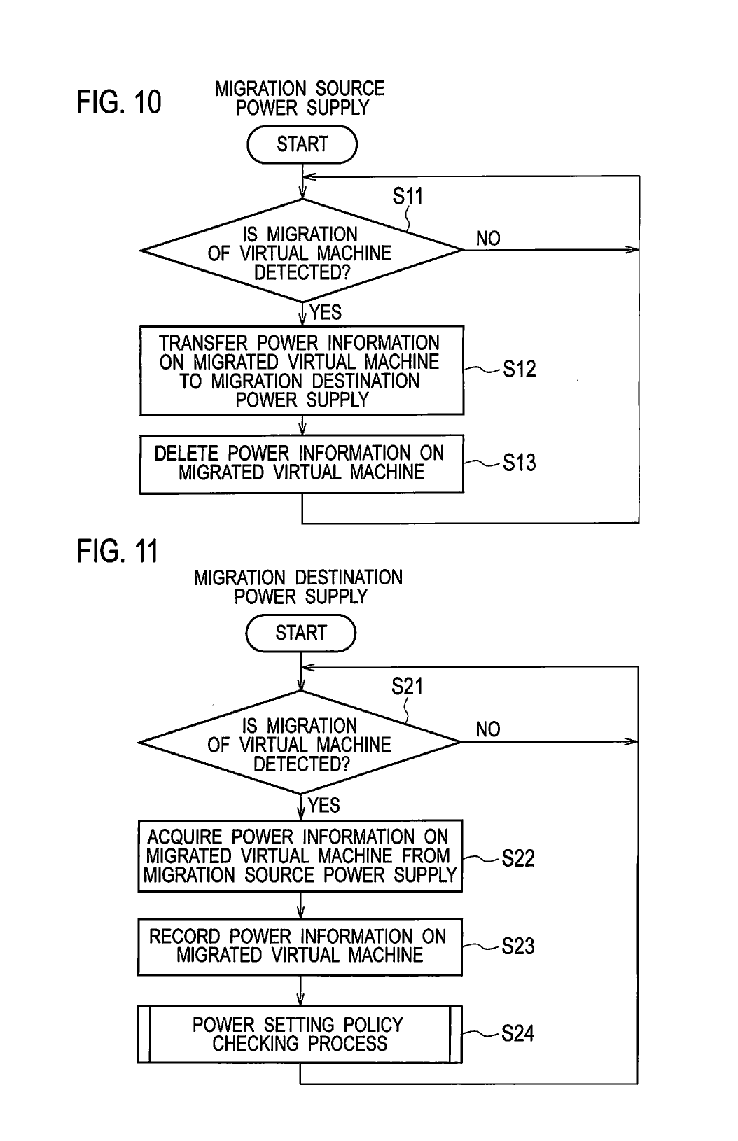

Now, referring to FIG. 10, description will be given of processing of the VM power data transfer unit 23 of the second power supply 1b being a migration source.

In step S11, the second power supply 1b detects migration of the fifth VM 3e and proceeds to step S12. In step S12, the second power supply 1b extracts the power information on the fifth VM 3e being the migrated VM out of the VM power management data 12 and transfers it to the first power supply 1a being the migration destination. In step S13, the second power supply 1b deletes or disables the power information on the fifth VM 3e being the migrated VM in the VM power management data 12 and terminates the processing.

Referring to FIG. 11, description will be given of processing of the VM power data transfer unit 23 of the first power supply 1a being the migration destination.

In step S21, the first power supply 1a detects the migration of the fifth VM 3e and proceeds to step S22. In step S22, the first power supply 1a acquires the power information on the fifth VM 3e being the migrated VM from the second power supply 1b. In step S23, the first power supply 1a records or enables the power information on the fifth VM 3e being the migrated VM in the VM power management data 12 and proceeds to step S24. In step S24, the first power supply 1a executes a power setting policy checking process and terminates the processing.

The power setting policy checking unit 24 is configured to determine whether or not the power information on a VM 3 which is migrated satisfies the condition in the power setting policy data 13. If the power information does not match the condition, power setting policy checking unit 24 notifies of an alerter. Here, suppose that the power information contains the delay time to stop for which the VM 3 waits for the start of its shutdown, and the shutdown time required for the VM 3 to shut down. In this case, the power setting policy data 13 contains a condition that requires completion of a shutdown of the virtual host computer 2 and its VM 3 within the available backup time for which a different power supply 1 can feed power. Here, the power setting policy checking unit 24 acquires, from the VM power management data 12, the greatest sum of the delay time to stop and the shutdown time among those of the VMs 3 run in emulation by the migration destination virtual host computer 2. The power setting policy checking unit 24 notifies of an alerter if the sum of the acquired greatest sum and the time required for the migration destination virtual host computer 2 to shut down is greater than the available backup time.

Besides the above case, if the power supply 1 cannot feed power to the new VM, the power setting policy checking unit 24 notifies of an alerter indicating that fact. For example, as shown in the power setting policy data 13 in FIG. 8, the power setting policy checking unit 24 acquires a state of the power supply 1 such as the load factor, power receiving status, or running status of the power supply 1, and notifies of an alerter if the acquired state does not satisfy the condition in the power setting policy data 13.

Here, the states of the power supply 1 such as the available backup time, load factor, power receiving status, and running status of the power supply 1 are stored in the memory 10 of the power supply 1 in advance.

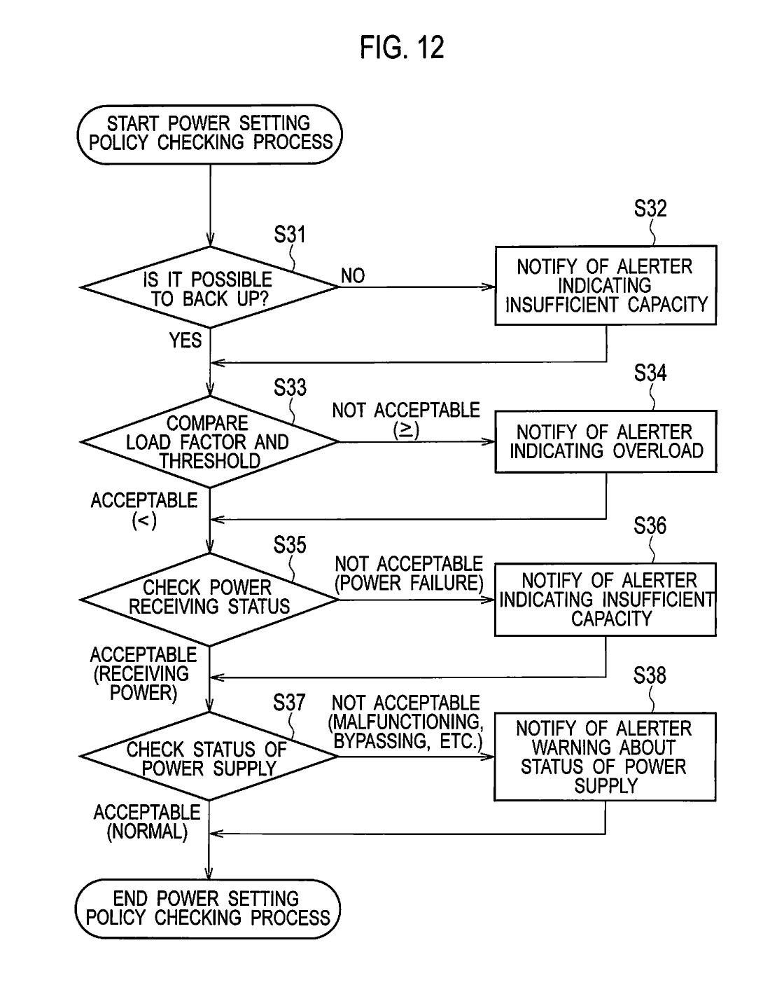

Referring to FIG. 12, description will be given of processing of the power setting policy checking unit 24.

First, in step S31, the power setting policy checking unit 24 determines whether the power supply 1 can feed power until the VMs 3 and the virtual host shut down. If the power supply 1 cannot feed power until the VMs 3 and the virtual host 2 shut down, the power setting policy checking unit 24 notifies in step S32 of an alerter indicating that the power capacity is insufficient, and then proceeds to step S33.

In step S33, the power setting policy checking unit 24 acquires the load factor of the power supply 1 and compares it to the threshold set in the power setting policy data 13. If the load factor of the power supply 1 is equal to or greater than the threshold set in the power setting policy data 13, the power setting policy checking unit 24 notifies in step S34 of an alerter indicating that the load on the power supply 1 is high, and then proceeds to step S35.

In step S35, the power setting policy checking unit 24 acquires the power receiving status of the power supply 1. As shown in the power setting policy data 13, if the power receiving status of the power supply 1 is “power failure,” the power setting policy checking unit 24 notifies in step S36 of an alerter indicating that the capacity of the power supply 1 is insufficient, and then proceeds to step S37.

In step S37, the power setting policy checking unit 24 acquires the running status of the power supply 1. As shown in the power setting policy data 13, if the running status of the power supply 1 is an abnormal status such as “malfunctioning” or “bypassing,” the power setting policy checking unit 24 notifies in step S38 of an alerter indicating that the power supply 1 is experiencing abnormality.

As described above, the power supply 1 determines whether or not the power information on the VMs 3 and the states of the power supply 1 match the conditions in the power setting policy data 13, and, if they do not match the conditions, notifies of alerters to let the administrator recognize such facts. The conditions shown in FIGS. 8 and 12 are mere examples; only some of the conditions may be considered, or some other conditions may be additionally considered.

As described above, the power supply 1 according to the embodiment of the present invention can collectively manage the virtual power source of each VM 3 and the physical power source of each virtual host 2. Thus, when a VM 3 is migrated to a given virtual host 2, the power information on the migrated VM 3 is transferred to the power supply 1 which feeds power to the migration destination virtual host 2 in response to this migration. Accordingly, it is possible to run the virtual system 9 while maintaining match between the settings of the virtual power source of each VM 3 and the settings of the physical power source of its virtual host 2.

Moreover, for start and stop of the running of the VM 3 and the virtual host 2, the power supply 1 according to the embodiment of the present invention is configured such that the power supply 1 sends commands related to start of the running of the VM 3, reboot of the VM 3, stop of the VM 3 and the virtual host 2. Because the power supply 1 can send commands related to start and stop of the running of apparatuses as described above, the system configuration for starting and stopping the running of the apparatuses in the virtual system 9 can be simplified. Accordingly, it is possible to easily implement system construction, system operation, and system maintenance of the virtual system 9.

Moreover, because the power supply 1 sends commands related to start and stop of the running of the VMs 3, the VMs 3 can be stopped quickly and safely even in situations where normal operation is impossible such as when the power supply 1 is malfunctioning and when the battery is low.

### (Modification)

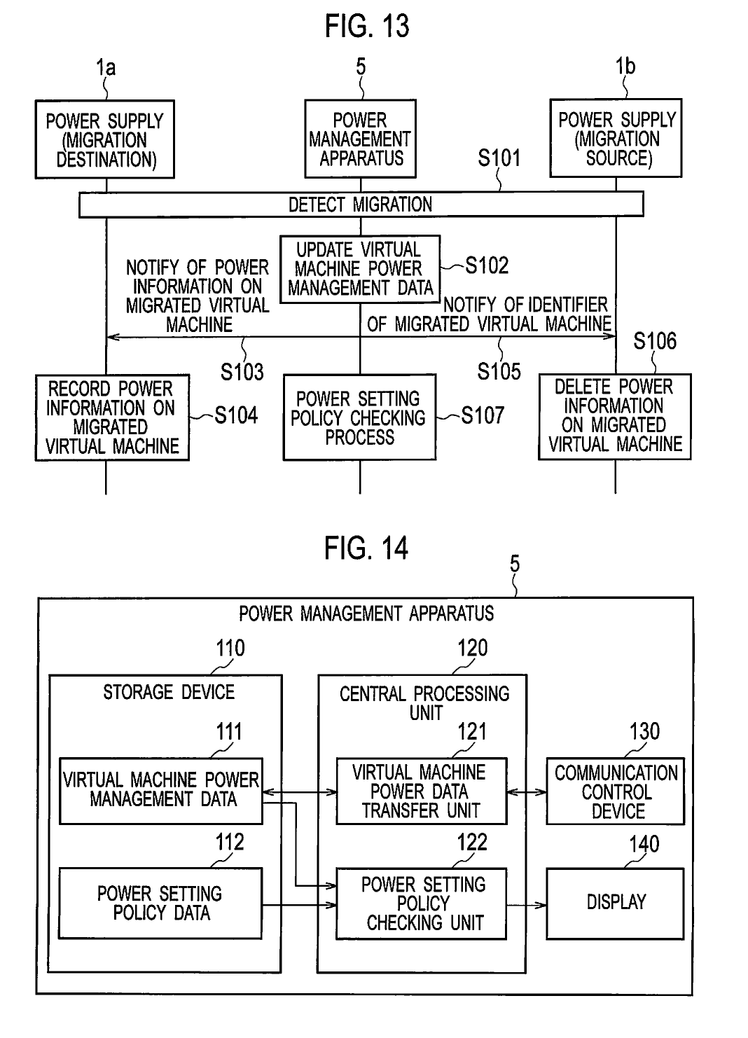

Referring to FIGS. 13 to 15, description will be given of processing for transferring the power information on a VM 3 in the virtual system 9 according to a modification. In the modification, the power management apparatus 5 holds each piece of power information of the virtual system 9, and upon migration of a VM 3, the power management apparatus 5 transfers the power information on the migrated VM 3 to the power supply 1 which feeds power to the migration destination virtual host 2.

Referring to FIG. 13, description will be given of processing of the virtual system 9 according to the modification. In the following, described is a case where the virtualization management server 4 migrates the fifth VM 3e from the third virtual host 2c to the first virtual host 2a, like the case shown in FIG. 2.

First, in step S101, the power management apparatus 5 detects that the fifth VM 3e has been migrated from the third virtual host 2c to the first virtual host 2a under the control of the virtualization management server 4. In the modification of the present invention, the manner in which the power management apparatus 5 detects migration of a VM 3 is not particularly limited.

When the power management apparatus 5 detects the migration of the fifth VM 3e, the power management apparatus 5 updates VM power management data 111 in accordance with the migration in step S102. Specifically, the power management apparatus 5 updates the VM power management data 111 to change the virtual host which runs the migrated fifth VM 3e in emulation from the third virtual host 2c to the first virtual host 2a.

In step S103, the power management apparatus 5 transfers the power information on the migrated fifth VM 3e by sending the power information to the first power supply 1a being the migration destination power supply. In step S104, the first power supply 1a stores or enables the power information on the fifth VM 3e received in step S103, and the sends commands related to start and stop of the running of the fifth VM 3e in accordance with the power information.

On the other hand, in step S105, the power management apparatus 5 notifies the second power supply 1b being the migration source power supply of the identifier of the migrated fifth VM 3e. In step S106, the second power supply 1b being the migration source deletes or disables the power information on the migrated fifth VM 3e.

Once notifying the migration source and migration destination power supplies 1 of the migration, the power management apparatus 5 determines whether the setting policy of the migration destination first power supply 1a satisfies the settings of the migrated fifth VM 3e. This determination process is as described above with reference to FIG. 8.

Referring to FIG. 14, description will be given of the power management apparatus 5 according to the modification. A storage device 110 of the power management apparatus 5 is configured to store a power management program and also store the VM power management data 111 and power setting policy data 112. A central processing unit 120 includes a VM power data transfer unit 121 and a power setting policy checking unit 122 when the central processing unit 120 executes the power management program.

Here, the power setting policy data 112 and the power setting policy checking unit 122 are as described above in the embodiment of the present invention.

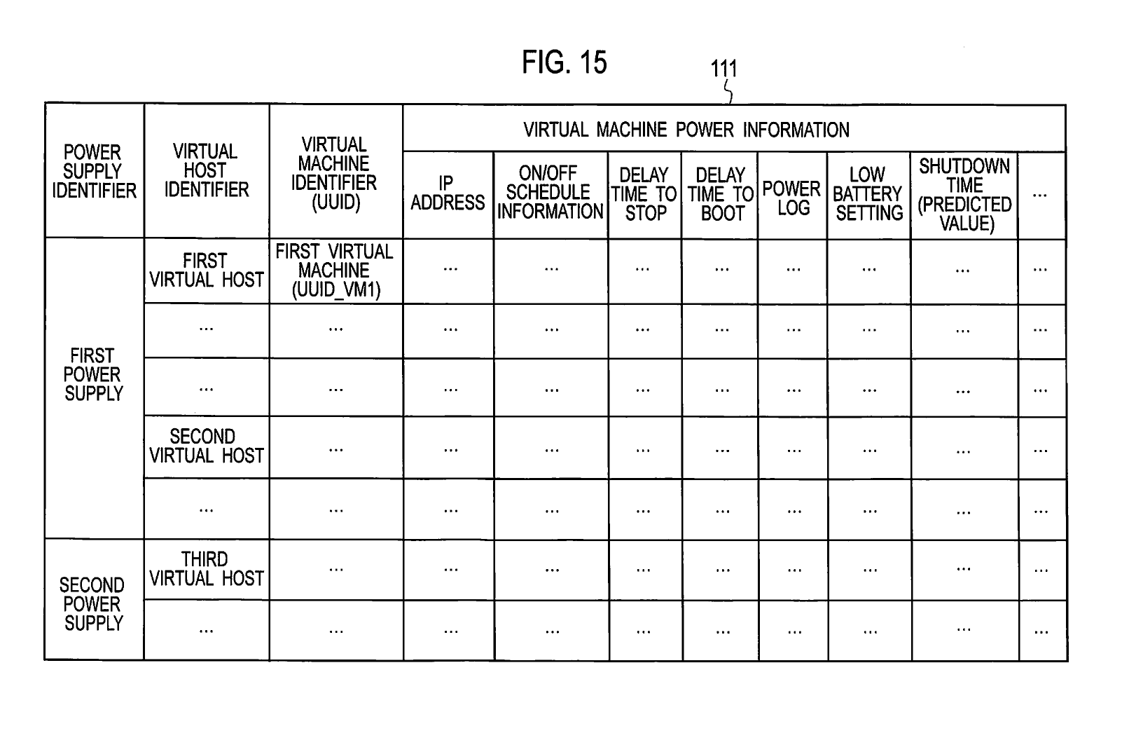

As shown in FIG. 15, the VM power management data 111 is data in which an identifier of each power supply, the identifier of the VM 3 run in emulation by the virtual host 2 fed with power from the power supply, and the power information on the VM 3 are associated with each other. Because the power management apparatus 5 manages the VMs of multiple power supplies 1, the VM power management data 111 according to the modification differs from the VM power management data 12 according to the embodiment described with reference to FIG. 5 in that the VM power management data 111 includes a column for the identifier of each power supply 1.

When the virtualization management server 4 migrates a VM 3 from the first virtual host computer 2a to the second virtual host computer 2b, the VM power data transfer unit 23 extracts the power information on the migrated VM 3 out of the VM power management data 111 and transfers it to the second power supply 1b.

Because the power management apparatus 5 collectively manages the information on multiple power supplies 1 as described above, it is possible to easily implement transfer of the power information on a VM 3 due to migration of the VM 3. Accordingly, the processing load on each power supply 1 can be reduced.

While the example shown in FIG. 13 has described the case where the power management apparatus 5 checks the power information policy, the present invention is not limited to this case. For example, the migration destination power supply may check the policy, as shown in FIG. 2.

### Other Embodiments

Although the description has been given using the embodiment of the present invention, it should not be understood that the statement and drawings constituting part of this disclosure limit this invention. Various alternative embodiments, examples, and operation techniques become apparent to those skilled in the art from this disclosure.

For example, the sequence of the processes shown in the sequence diagrams in FIGS. 2, 13, etc. and the flowcharts in FIGS. 10 to 12, etc. are mere examples, and can be changed as long as the change does not cause contradiction.

Moreover, in the embodiment and the modification of the present invention, the power management apparatus 5 is described as a general computer with a given program installed therein. However, the present invention is not limited to this case. The power management apparatus 5 may be a computer such as what is called a power management box designed for management of one or more power supplies 1.

Moreover, the power management apparatus 5 may be a power supply with a given program installed therein. The power management apparatus 5 may be configured to perform power management of the power supplies 1 shown in FIGS. 1A and 1B, in addition to power feed to the computers shown in FIGS. 1A and 1B and computers other than the computers shown in FIGS. 1A and 1B. In this case, the computer incorporated in each power supply 1 executes each process by following the given program.

Further, as another embodiment, the first power supply 1a shown in FIGS. 1A and 1B may function as the power management apparatus 5 as well. Specifically, the first power supply 1a may hold the VM information on the VMs 3 run in emulation by the virtual hosts 2 fed with power from the first power supply 1a, and also hold the VM information on the VM 3 run in emulation by the virtual host 2 fed with power from the second power supply 1b. Moreover, upon migration of a VM 3, the first power supply 1a may send its VM information to the second power supply 1b and instruct the second power supply 1b to store to the VM information, or instruct the second power supply 1b to delete the VM information. Similarly, upon migration of a VM 3, the first power supply 1a may instruct the second power supply 1b to enable or disable its VM information.

The present invention includes various embodiments and the like that are not described herein, as a matter of course. Therefore, the technical scope of the present invention shall be determined solely by the specified matters in the invention according to the claims that are appropriate from the above description.

What is claimed is:

1. A power supply which feeds power to a virtual host computer running a virtual machine in emulation, the virtual machine controlled by a virtualization management server, the power supply comprising:
a storage device configured to store virtual machine power management data in which an identifier of the virtual machine run in emulation by the virtual host computer fed with power from the power supply, and power information on the virtual machine are associated with each other; and
a virtual machine power data transfer unit configured to, when the virtualization management server migrates the virtual machine run in emulation by the virtual host computer fed with power from the power supply to a migration destination virtual host computer fed with power from a different power supply, extract the power information on the migrated virtual machine out of the virtual machine power management data, and transfer the power information to the different power supply.

2. The power supply according to claim 1, wherein
the storage device further stores power setting policy data being data containing a condition that allows the power supply to feed power for running the virtual machine,
if a new virtual machine is migrated and to be run in emulation, the virtual machine power data transfer unit acquires the power information on the new virtual machine and stores the power information in the virtual machine power management data, and
the power supply further comprises a power setting policy checking unit configured to determine whether or not the power information on the new virtual machine satisfies the condition in the power setting policy data, and notify of an alerter if the power information does not match the condition.

3. The power supply according to claim 2, wherein
the power information contains a delay time to stop for which the virtual machine waits for start of a shutdown thereof, and a shutdown time required for the virtual machine to shut down,
the power setting policy data contains a condition that requires completion of a shutdown of the virtual host computer and the virtual machine within an available backup time for which the different power supply is capable of feeding power, and
the power setting policy checking unit acquires, from the virtual machine power management data, the greatest sum of the delay time to stop and the shutdown time among those of the virtual machines run in emulation by the migration destination virtual host computer, and notifies of an alerter if the sum of the acquired greatest sum and a time required for the migration destination virtual host computer to shut down is greater than the available backup time.

4. A program being on a non-transitory computer-readable storage medium for a power supply which feeds power to a virtual host computer running a virtual machine in emulation, the virtual machine controlled by a virtualization management server, the program configured to execute the steps of:
storing, in a storage device, virtual machine power management data in which an identifier of the virtual machine run in emulation by the virtual host computer fed with power from the power supply, and power information on the virtual machine are associated with each other; and
when the virtualization management server migrates the virtual machine run in emulation by the virtual host computer fed with power from the power supply to a migration destination virtual host computer fed with power from a different power supply, extracting the power information on the migrated virtual machine out of the virtual machine power management data, and transferring the power information to the different power supply.

5. A control method used for a power supply which feeds power to a virtual host computer running a virtual machine in emulation, the virtual machine controlled by a virtualization management server, the control method comprising the steps of:
storing virtual machine power management data in which an identifier of the virtual machine run in emulation by the virtual host computer fed with power from the power supply, and power information on the virtual machine are associated with each other; and
when the virtualization management server migrates the virtual machine run in emulation by the virtual host computer fed with power from the power supply to a migration destination virtual host computer fed with power from a different power supply, extracting the power information on the migrated virtual machine out of the virtual machine power management data, and transferring the power information to the different power supply.

6. A power management apparatus connected to a first power supply which feeds power to a first virtual host computer and a second power supply which feeds power to a second virtual host computer, the power management apparatus comprising:
a storage device configured to store virtual machine power management data in which an identifier of each of the power supplies, an identifier of a virtual machine run in emulation by the virtual host computer fed with power from the power supply, and power information on the virtual machine are associated with each other; and
a virtual machine power data transfer unit configured to, when a virtualization management server migrates the virtual machine from the first virtual host computer to the second virtual host computer, extract the power information on the migrated virtual machine out of the virtual machine power management data, and transfer the power information to the second power supply.

7. The power management apparatus according to claim 6, wherein
the storage device further stores power setting policy data containing the identifier of each of the power supplies and a condition that allows the power supply to feed power, and
the power management apparatus further comprises a power setting policy checking unit configured to extract the condition of the second power supply out of the power setting policy data, determine whether or not the power information on the migrated virtual machine satisfies the condition of the second power supply in the power setting policy data, and notify of an alerter if the power information does not match the condition.

8. The power management apparatus according to claim 7, wherein
the power information contains a delay time to stop for which the virtual machine waits for start of a shutdown thereof, and a shutdown time required for the virtual machine to shut down,
the power setting policy data contains a condition that requires completion of a shutdown of the second virtual host computer and the virtual machine run in emulation by the second virtual host computer within an available backup time for which the second power supply is capable of feeding power, and
the power setting policy checking unit acquires, from the virtual machine power management data, the greatest sum of the delay time to stop and the shutdown time among those of the virtual machines run in emulation by the second virtual host computer, and notifies of an alerter if the sum of the acquired greatest sum and a time required for the second virtual host computer to shut down is greater than the available backup time.

9. A power management program used for a power management apparatus connected to a first power supply which feeds power to a first virtual host computer and a second power supply which feeds power to a second virtual host computer, the power management program configured to execute the steps of:
storing, in a storage device, virtual machine power management data in which an identifier of each of the power supplies, an identifier of a virtual machine run in emulation by the virtual host computer fed with power from the power supply, and power information on the virtual machine are associated with each other; and
when a virtualization management server migrates the virtual machine from the first virtual host computer to the second virtual host computer, extracting the power information on the migrated virtual machine out of the virtual machine power management data, and transferring the power information to the second power supply.
